(19) United States
(12) Patent Application Publication
(10) Pub. No.: US 2025/0209849 A1
(43) Pub. Date: Jun. 26, 2025

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Akihiro HAYASAKA, Tokyo (JP)

(73) Assignee: NEC Corporation, Minato-ku, Tokyo (JP)

(21) Appl. No.: 18/851,765

(22) PCT Filed: May 16, 2022
(86) PCT No.: PCT/JP2022/020343

§ 371 Date: Sep. 27, 2024

(51) Int. Cl. G06V 40/16; G06T 5/50

(52) U.S. Cl. CPC G06V 40/161; G06T 5/50; G06V 40/174; G06T 2207/20221

(57) ABSTRACT

An information processing apparatus includes: an acquisition unit that acquires information about a person including at least an image of the person; a detection unit that detects a face area including a face of the person from the image; an estimation unit that estimates a hidden shield area in a case where at least a part of the face area is hidden; an expression estimation unit that estimates an expression of the person on the basis of the information about the person; an estimated expression image generation unit that generates an estimated expression image of an area corresponding to the shield area, in accordance with the expression estimated by the expression estimation unit; and a composite image generation unit that generates a composite image on the basis of the image and the estimated expression image.

### TECHNICAL FIELD

This disclosure relates to technical fields of an information processing apparatus, an information processing method, and a recording medium.

### BACKGROUND ART

Patent Literature 1 discloses a technique/technology of: determining a shielding region of an input image serving as an image that illustrates a face; and identifying the input image by using a region other than a region related to a shielding pattern based on the shielding region, thereby increasing the accuracy of recognizing a face image including the shielding region. Patent Literature 2 describes a technique/technology of: inputting a face image; detecting areas including regions such as eyes, nose, mouth and cheeks, included in the face image; painting out an inside of the detected regional areas; and combining region images stored in advance, with the face image in which the regional areas are painted out. Patent Literature 3 describes a technique/technology of: capturing a front image (moving image) of a user over a head mount display at a position of a camera that is attached to the head mount display; using, as it is, a face area that is not hidden by the head mount display in the moving image; replacing an area hidden by the head mount display, with an area extracted by a mask pattern of the head mount display from a still image that is preliminarily photographed at the same view point and that is accumulated in an accumulating means when the head mount display is not mounted; pasting a face image synthesized from the moving image and the still image on a surface of an appropriate solid body, such as a cube, with a texture mapping algorithm; and outputting or displaying it as a head of a person.

### CITATION LIST

### Patent Literature

Patent Literature 1: JP2021-103538A
Patent Literature 2: JP2002-352258A
Patent Literature 3: JPH11-096366A

### SUMMARY

### Technical Problem

It is an example object of this disclosure to provide an information processing apparatus, an information processing method, and a recording medium that aim to improve the techniques/technologies disclosed in Citation List.

### Solution to Problem

An information processing apparatus according to an example aspect of this disclosure includes: an acquisition unit that acquires information about a person including at least an image of the person; a detection unit that detects a face area including a face of the person from the image; an estimation unit that estimates a hidden shield area in a case where at least a part of the face area is hidden; an expression estimation unit that estimates an expression of the person on the basis of the information about the person; an estimated expression image generation unit that generates an estimated expression image of an area corresponding to the shield area, in accordance with the expression estimated by the expression estimation unit; and a composite image generation unit that generates a composite image on the basis of the image and the estimated expression image.

An information processing method according to an example aspect of this disclosure includes: acquiring information about a person including at least an image of the person; detecting a face area including a face of the person from the image; estimating a hidden shield area in a case where at least a part of the face area is hidden; estimating an expression of the person on the basis of the information about the person; generating an estimated expression image of an area corresponding to the shield area, in accordance with the estimated expression; and generating a composite image on the basis of the image and the estimated expression image.

A recording medium according to an example aspect of this disclosure is a recording medium on which a computer program that allows a computer to execute an information processing method is recorded, the information processing method including: acquiring information about a person including at least an image of the person; detecting a face area including a face of the person from the image; estimating a hidden shield area in a case where at least a part of the face area is hidden; estimating an expression of the person on the basis of the information about the person; generating an estimated expression image of an area corresponding to the shield area, in accordance with the estimated expression; and generating a composite image on the basis of the image and the estimated expression image.

### BRIEF DESCRIPTION OF DRAWINGS

FIG. 1 is a block diagram illustrating a configuration of an information processing apparatus in a first example embodiment.

FIG. 2 is a block diagram illustrating a configuration of an information processing apparatus in a second example embodiment.

FIG. 3 is a flowchart illustrating a flow of an information processing operation performed by the information processing apparatus in the second example embodiment.

FIG. 4 is a block diagram illustrating a configuration of an information processing apparatus in a fourth example embodiment.

FIG. 5 is a flowchart illustrating a flow of a learning operation performed by the information processing apparatus in the fourth example embodiment.

FIG. 6 is a flowchart illustrating a flow of an estimated expression image generation operation performed by an information processing apparatus in a fifth example embodiment.

FIG. 7 is a block diagram illustrating a configuration of an information processing apparatus in a sixth example embodiment.

FIG. 8 is a conceptual diagram illustrating a display example by display control by the information processing apparatus in the sixth example embodiment.

FIG. 9 is a conceptual diagram of an online meeting system in a seventh example embodiment.

FIG. 10 is a block diagram illustrating a configuration of an online meeting control apparatus in the seventh example embodiment.

FIG. 11 is a flowchart illustrating a flow of an online meeting control operation performed by the online meeting control apparatus in the seventh example embodiment.

### DESCRIPTION OF EXAMPLE EMBODIMENTS

Hereinafter, an information processing apparatus, an information processing method, and a recording medium according to example embodiments will be described with reference to the drawings.

### 1: First Example Embodiment

An information processing apparatus, an information processing method, and a recording medium according to a first example embodiment will be described. The following describes the information processing apparatus, the information processing method, and the recording medium according to the first example embodiment, by using an information processing apparatus 1 to which the information processing apparatus, the information processing method, and the recording medium according to the first example embodiment are applied.

### [1-1: Configuration of Information Processing Apparatus 1]

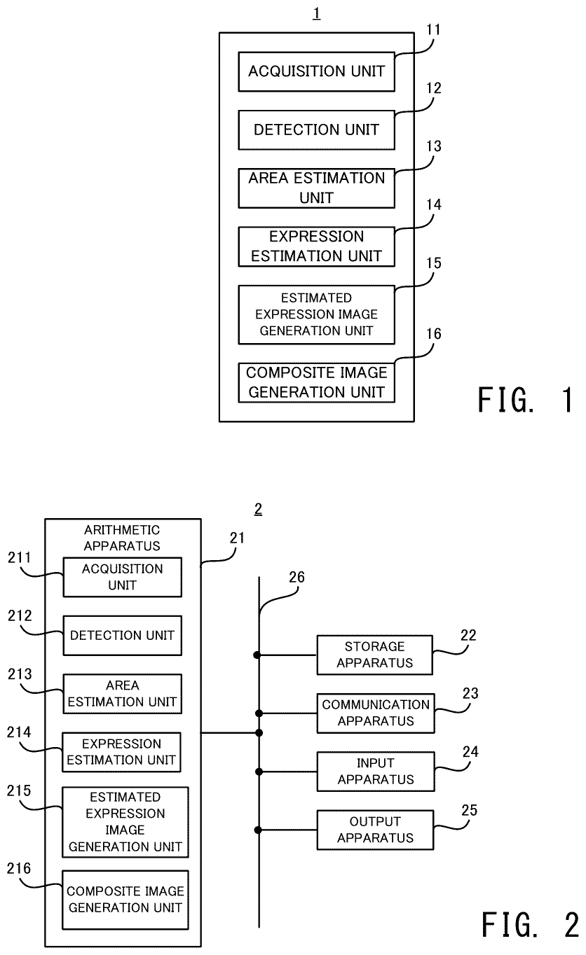

With reference to FIG. 1, a configuration of the information processing apparatus 1 in the first example embodiment will be described. FIG. 1 is a block diagram illustrating the configuration of the information processing apparatus 1 in the first example embodiment.

As illustrated in FIG. 1, the information processing apparatus 1 includes an acquisition unit 11, a detection unit 12, an area estimation unit 13, an expression estimation unit 14, an estimated expression image generation unit 15, and a composite image generation unit 16. The acquisition unit 11 acquires information about a person, including at least an image of the person. The detection unit 12 detects a face area including a face of the person from the image. The area estimation unit 13 estimates a hidden shield area in a case where at least a part of the face area is hidden. The expression estimation unit 14 estimates an expression of the person on the basis of the information about the person. The estimated expression image generation unit 15 generates an estimated expression image of an area corresponding to the shield area according to the expression estimated by the expression estimation unit 14. The composite image generation unit 16 generates a composite image on the basis of the image and the estimated expression image.

### [1-2: Technical Effect of Information Processing Apparatus 1]

Since the information processing apparatus 1 in the first example embodiment generates the composite image on the basis of the image and the image according to the estimated expression of the person, even in a case where at least a part of the face area of the person is hidden, it is possible to acquire the image (i.e., the composite image) according to the expression of the person in which the face area of the person is not hidden.

### 2: Second Example Embodiment

An information processing apparatus, an information processing method, and a recording medium according to a second example embodiment will be described. The following describes the information processing apparatus, the information processing method, and the recording medium according to the second example embodiment, by using an information processing apparatus 2 to which the information processing apparatus, the information processing method, and the recording medium according to the second example embodiment are applied.

### [2-1: Configuration of Information Processing Apparatus 2]

With reference to FIG. 2, a configuration of the information processing apparatus 2 in the second example embodiment will be described. FIG. 2 is a block diagram illustrating the configuration of the information processing apparatus 2 in the second example embodiment.

As illustrated in FIG. 2, the information processing apparatus 2 includes an arithmetic apparatus 21 and a storage apparatus 22. Furthermore, the information processing apparatus 2 may include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. Arithmetic apparatus 21 reads a computer program. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical functional block for performing an operation to be performed by the information processing apparatus 2 is realized or implemented in the arithmetic apparatus 21. That is, the arithmetic apparatus 21 is allowed to function as a controller for realizing or implementing the logical functional block for performing an operation (in other words, processing) to be performed by the information processing apparatus 2.

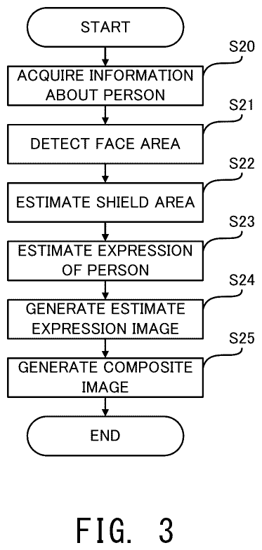

FIG. 2 illustrates an example of the logical functional block realized or implemented in the arithmetic apparatus 21 to perform an information processing operation. As illustrated in FIG. 2, an acquisition unit 211 that is a specific example of the “acquired unit” described in Supplementary Note later, a detection unit 212 that is a specific example of the “detected unit” described in Supplementary Note later, an area estimation unit 213 that is a specific example of the “estimated unit” described in Supplementary Note later, an expression estimation unit 214 that is a specific example of the “expression estimation unit” described in Supplementary Note later, an estimated expression image generation unit 215 that is a specific example of the “estimated expression image generation unit” described in Supplementary Note later, and a composite image generation unit 216 that is a specific example of the “composite image generation unit” described in Supplementary Note later, are realized or implemented in the arithmetic apparatus 21. Each operation of the acquisition unit 211, the detection unit 212, the area estimation unit 213, the expression estimation unit 214, the estimated expression image generation unit 215, and the composite image generation unit 216 will be described later with reference to FIG. 3.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The communication apparatus 23 is configured to communicate with an apparatus external to the information processing apparatus 2 through a not-illustrated communication network.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### [2-2: Information Processing Operation Performed by Information Processing Apparatus 2]

With reference to FIG. 3, a flow of an information processing operation performed by the information processing apparatus 2 in the second example embodiment will be described. FIG. 3 is a flowchart illustrating the flow of the information processing operation performed by the information processing apparatus 2 in the second example embodiment.

As illustrated in FIG. 3, the acquisition unit 211 acquires the information about the person including at least the image of the person (step S20). As the information about the person, the acquisition unit 211 may acquire, for example, audio information or the like acquired when the image of the person is generated, in addition to the image of the person.

The detection unit 212 detects the face area including the face of the person from the image (step S21). The detection unit 212 may detect the face area by applying known face detection processing to the image. The detection unit 212 may detect an area having features of the face, as the face area. The area having the features of the face may be an area including characteristic parts that constitute the face, such as eyes, a nose, and a mouth. There is no particular limitation on a method of detecting the face area performed by the detection unit 212. The detection unit 212 may detect the face area, for example, on the basis of extraction of an edge/pattern that is characteristic of the face area.

The detection unit 212 may detect the face area by using a neural network that has machine-learned the detection of the face area. The detection unit 212 may include a convolutional neural network (hereinafter, also referred to as a “CNN”).

When at least a part of the face area is hidden, the area estimation unit 213 estimates the hidden shield area (step S22). In the second example embodiment, the shield area that is at least a hidden part of the face area, may be a mask area hidden by a mask worn by the person. When at least a part of the face area is hidden by the mask worn by the person, the area estimation unit 213 may estimate the hidden mask area. The area estimation unit 213 may determine that the face area includes the mask area, for example, when feature points such as nose wings and corners of the mouth, are not detected from the face area. The mask area hidden by the mask may be a predetermined area including the nose wings, the corners of the mouth, or the like.

The expression estimation unit 214 estimates the expression of the person on the basis of the information about the person (step S23). When at least a part of the face area is hidden by the mask worn by the person, the expression estimation unit 214 may adopt information that is acquirable from other than the mask area, as the information about the person. In this instance, the expression estimation unit 214 may estimate the expression of the person on the basis of information that is acquirable from an area other than the mask area included in the face area. Furthermore, the expression estimation unit 214 may estimate the expression of the person on the basis of at least one of an angle of the face, a pose of the person, and a gesture made by the person, in addition to or instead of the information that is acquirable from the area other than the mask area included in the face area. The expression estimation unit 214 may estimate the expression of the person on the basis of the audio information acquired when the image of the person is generated, in addition to or instead of the information that is acquirable from the image of the person, for example. The audio information may include at least one of information indicating a state of utterance and information indicating speaking content. The state of utterance may include at least one of a tone and a tempo of the utterance. Furthermore, the expression estimation unit 214 may estimate the expression of the person on the basis of information indicating a surrounding situation when the image of the person is generated, in addition to or instead of the information about the person, for example. The expression estimation unit 214 may adopt information that improves estimation accuracy of the expression of the person, as the information about the person.

The expression estimation unit 214 may estimate the expression of the person, for example, on the basis of a predetermined rule. For example, the expression of the person may be estimated from a state of movement of muscles of the face. The state of movement of the muscles of the face may include at least one of a state of movement of raising an eyebrow, a state of movement of lowering the eyebrow, and a state of movement of raising a cheek. The expression estimation unit 214 may estimate the expression of the person by combining a plurality of states of movement of the muscles of the face. The expression estimation unit 214 may estimate the expression of the person to be at least any of an expression of joy, an expression of surprise, an expression of fear, an expression of disgust, an expression of anger, an expression of sadness, and a lack of expression. For example, when the cheek of the person is higher than a predetermined level, the expression estimation unit 214 may estimate that it is an expression of joy.

The second example embodiment exemplifies that the shield area that is at least a hidden part of the face area is the mask area hidden by the mask worn on the face; however, the shield area may be, for example, an area hidden by sunglasses. In this case, the expression estimation unit 214 may estimate the expression of the person from a state of the mouth. The state of the mouth may include, for example, at least one of a state of raising an upper lip, a state of raising the corners of the mouth, a state in which dimples appear, and a state of raising a chin, or the like.

The estimated expression image generation unit 215 generates the estimated expression image of the area corresponding to the shield area, in accordance with the expression estimated by the expression estimation unit 214 (step S24).

The composite image generation unit 216 generates the composite image on the basis of the image and the estimated expression image (step S25). The composite image generation unit 216 may generate the composite image such that at least the shield area is hidden by the estimated expression image. That is, the composite image generation unit 216 may complement the shield area of the face area of the person, by the image according to the estimated expression of the person.

### [2-3: Technical Effect of Information Processing Apparatus 2]

Since the information processing apparatus 2 in the second example embodiment generates the composite image on the basis of the image and the image of the mask area according to the estimated expression of the person, it is possible to acquire the image according to the expression of the person in which the mouth of the person is not hidden, even when the person is wearing the mask.

Due to recent changes in hygiene awareness, it is recommended that people wear masks, especially in a crowded place. When a commemorative picture is taken in the crowded place, such as, for example, a tourist spot, only faces wearing masks are captured, and it is a shame that the picture turns out to be bland and boring. That is, there is a demand to record a natural face image without the mask, even in a place where people are hesitant to take off masks, such as a crowded place.

In contrast, since the information processing apparatus 2 in the second example embodiment generates the composite image without the mask on the basis of the image of the area corresponding to the mask area, in accordance with the estimated expression of the person when the person is wearing the mask, it is possible to provide the natural face image without the mask. Therefore, the natural face image without the mask is included in the picture taken in the crowded place, and an attractive picture may be recorded.

### 3: Third Example Embodiment

An information processing apparatus, an information processing method, and a recording medium according to a third example embodiment will be described. The following describes the information processing apparatus, the information processing method, and the recording medium according to the third example embodiment, by using an information processing apparatus 3 to which the information processing apparatus, the information processing method, and the recording medium according to the third example embodiment are applied.

In the third example embodiment, when at least a part of the face area is hidden by the mask worn on the face, the expression estimation unit 214 may estimate the expression of the person on the basis of an area around eyes of the person in the face area, as the area other than the mask area included in the face area. The expression estimation unit 214 may estimate the expression of the person on the basis of information that is acquirable from the area around the eyes included in the face area.

The expression estimation unit 214 may extract the area around the eyes from the face area, on the basis of a distance between the eyes included in the face, for example. The expression estimation unit 214 may extract the area around the eyes from the face area, on the basis of both sides of a lower part of the dorsum of the nose included in the face.

The expression estimation unit 214 may estimate the expression of the person, for example, on the basis of the angle of the face, or the pose/gesture of the person, in addition to information about the area around the eyes included in the face area. The expression estimation unit 214 may estimate the expression of the person, for example, on the basis of the audio information acquired when the image of the person is generated, in addition to the information about the area around the eyes included in the face area. The expression estimation unit 214 may estimate the expression of the person, on the basis of the information indicating the surrounding situation when the image of the person is generated, in addition to the information about the area around the eyes included in the face area. As in the second example embodiment, the expression estimation unit 214 may adopt the information that improves the estimation accuracy of the expression of the person, as the information about the person.

### [Technical Effect of Information Processing Apparatus 3]

The information processing apparatus 3 in the third example embodiment is capable of estimating the expression of the face under the mask from information about the image of around the eyes, and generating a composite face image without the mask and with an appropriate expression.

### 4: Fourth Example Embodiment

An information processing apparatus, an information processing method, and a recording medium according to a fourth example embodiment will be described. The following describes the information processing apparatus, the information processing method, and the recording medium according to the fourth example embodiment, by using an information processing apparatus 4 to which the information processing apparatus, the information processing method, and the recording medium according to the fourth example embodiment are applied.

### [4-1: Configuration of Information Processing Apparatus 4]

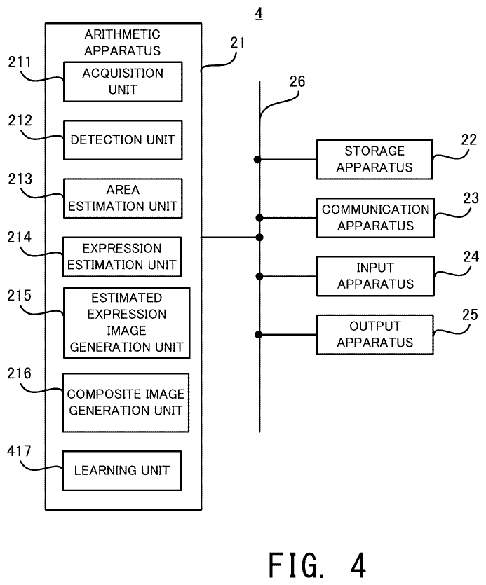

With reference to FIG. 4, a configuration of the information processing apparatus 4 in the fourth example embodiment will be described. FIG. 4 is a block diagram illustrating the configuration of the information processing apparatus 4 in the fourth example embodiment.

As illustrated in FIG. 4, the information processing apparatus 4 in the fourth example embodiment includes the arithmetic apparatus 21 and the storage apparatus 22, as in the information processing apparatus 2 in the second example embodiment and the information processing apparatus 3 in the third example embodiment. Furthermore, the information processing apparatus 4 may include the communication apparatus 23, the input apparatus 24, and the output apparatus 25, as in the information processing apparatus 2 in the second example embodiment and the information processing apparatus 3 in the third example embodiment. The information processing apparatus 4, however, may not include at least one of the communication apparatus 23, the input apparatus 24, and the output apparatus 25. The information processing apparatus 4 in the fourth example embodiment is different from the information processing apparatus 2 in the second example embodiment and the information processing apparatus 3 in the third example embodiment, in that the arithmetic apparatus 21 includes a learning unit 417 and performs a learning operation. Other features of the information processing apparatus 4 may be the same as those of at least one of the information processing apparatus 2 in the second example embodiment and the information processing apparatus 3 in the third example embodiment.

### [4-2: Learning Operation Performed by Information Processing Apparatus 4]

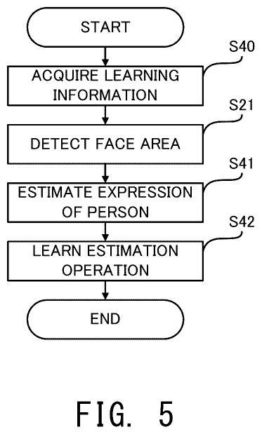

With reference to FIG. 5, a flow of a learning operation performed by the information processing apparatus 4 in the fourth example embodiment will be described. FIG. 5 is a flowchart illustrating the flow of the learning operation performed by the information processing apparatus 4 in the fourth example embodiment.

As illustrated in FIG. 5, the acquisition unit 211 acquires learning information including sample information about a sample person with a predetermined expression and an expression label indicating the predetermined expression (step S40). The predetermined expression may include at least any of an expression of joy, an expression of surprise, an expression of fear, an expression of disgust, an expression of anger, an expression of sadness, and a lack of expression. The expression label may be a label indicating each of these expressions. Furthermore, a label may be provided for each intensity of multiple stages of each expression.

The acquisition unit 211 may acquire, from the storage apparatus 22, the learning information stored in the storage apparatus 22. The acquisition unit 211 may acquire the learning information from an external apparatus through the communication apparatus 23.

The detection unit 212 detects the face area including the face of the person from the image (step S21). The expression estimation unit 214 estimates the expression of the sample person on the basis of the sample information (step S41).

The learning unit 417 causes the expression estimation unit 214 to learn a method of estimating the expression of the person on the basis of the expression label and an estimation result of the expression of the sample person by the expression estimation unit 214 (step S42). The learning unit 417 may build an expression estimation model capable of estimating the expression of the person for whom at least a part of the face area is hidden. The expression estimation unit 214 may estimate the expression of the person for whom at least a part of the face area is hidden, on the basis of the information about the person, by using the expression estimation model. The expression estimation unit 214 is capable of estimating the expression of the person for whom at least a part of the face area is hidden, with high accuracy. by using the learned expression estimation model.

A parameter that defines the operation of the expression estimation model may be stored in the storage apparatus 22. The parameter that defines the operation of the expression estimation model may be a parameter updated by the learning operation, and may be a weight, a bias, or the like of a neural network, for example.

In the image used to learn the expression of the face hidden by the mask area, it is sufficient to know a state of the person other than the mask area. That is, the learning may be performed by using the area other than the mask area. In other words, the image used for the learning may be an image with the mask, or an image without the mask.

### [4-3: Technical Effect of Information Processing Apparatus 4]

The information processing apparatus 4 in the fourth example embodiment is capable of realizing the estimation of the expression of the person with high accuracy by machine-learning.

### 5: Fifth Example Embodiment

An information processing apparatus, an information processing method, and a recording medium according to a fifth example embodiment will be described. The following describes the information processing apparatus, the information processing method, and the recording medium according to the fifth example embodiment, by using an information processing apparatus 5 to which the information processing apparatus, the information processing method, and the recording medium according to the fifth example embodiment are applied.

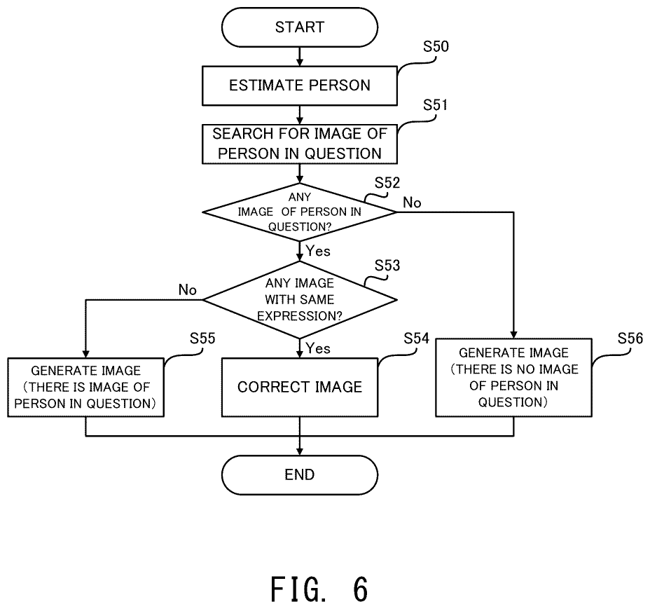

The information processing apparatus 5 in the fifth example embodiment will be described with reference to FIG. 6. The fifth example embodiment describes a specific example of an operation when the estimated expression image is generated in the second to fourth example embodiments described above (i.e., an operation corresponding to the step S24 in FIG. 3). In the fifth example embodiment, images of the person with various expressions in which at least the shield area is not hidden, may be registered in the storage apparatus 22 in advance. The other part of the operation when the estimated expression image is generated, may be the same as at least one of those in the second to fourth example embodiments. For this reason, a part that is different from each of the example embodiments described above will be described in detail below, and a description of the other overlapping parts will be omitted as appropriate.

### [5-1: Estimated Expression Image Generation Operation Performed by Information Processing Apparatus 5]

With reference to FIG. 6, a flow of an estimated expression image generation operation (i.e., an operation when the estimated expression image is generated) by the information processing apparatus 5 in the fifth example embodiment will be described. FIG. 6 is a flowchart illustrating the flow of the estimated expression image generation operation by the information processing apparatus 5 in the fifth example embodiment.

As illustrated in FIG. 6, the estimated expression image generation unit 215 estimates who is a processing target person (step S50). The estimated expression image generation unit 215 may perform face authentication using the face area detected by the detection unit 212 and may estimate who is the processing target person.

The estimated expression image generation unit 215 searches for and acquires an image that is estimated to be an image of the processing target person (hereinafter referred to as a “person in question” in some cases), from previously registered images of persons in which at least the shield area is not hidden (step S51). The estimated expression image generation unit 215 determines whether or not the image of the person in question is acquirable, in the step S51 (step S52).

In the step S51, when the image of the person in question is acquirable (the step S52: Yes), the estimated expression image generation unit 215 determines whether or not there is an image of the person in question with an expression corresponding to the expression estimated in the step S23 (step S53). The expression corresponding to the estimated expression may include an expression that matches or is similar to the estimated expression.

When there is the image of the person in question with the expression corresponding to the expression estimated in the step S23 (the step S53: Yes), the estimated expression image generation unit 215 generates the estimated expression image on the basis of the previously registered image of the person in question with the expression corresponding to the expression estimated by the expression estimation unit 214 (step S54). The estimated expression image generation unit 215 may generate the estimated expression image, by selecting the previously registered image of the person in question with the expression corresponding to the expression estimated by the expression estimation unit 214 and correcting brightness of the image, a posture of the person, or the like.

When there is no image of the person in question with the expression corresponding to the expression estimated in the step S23 (the step S53: No), the estimated expression image generation unit 215 generates the estimated expression image on the basis of the previously registered image of the person in question in which at least shield area is not hidden (step S55). When there is no previously registered image of the person in question with the expression corresponding to the expression estimated by the expression estimation unit 214, the estimated expression image generation unit 215 may generate the estimated expression image by selecting any image of the person in question and converting the expression of the image into the expression corresponding to the expression estimated by the expression estimation unit 214. The estimated expression image generation unit 215 may generate the image with the expression corresponding to the expression estimated by the expression estimation unit 214, as the estimated expression image, by applying a deep learning technique/technology such as, for example, a GAN (Generative Adversarial Network).

In the step S51, when the image of the person in question is not acquirable (the step S52: No), the estimated expression image generation unit 215 may generate the image with the expression corresponding to the expression estimated by the expression estimation unit 214, as the estimated expression image, by applying the deep-learning technique/technology such as, for example, a GAN (step S56).

As for the image of the person in question, only one image may be registered per person. That is, the estimated expression image generation unit 215 may omit the step S53 and may perform the step S55. The estimated expression image generation unit 215 may generate the estimated expression image by applying the deep-learning technique/technology such as, for example, a GAN, regardless of the presence or absence of the image of the person in question. That is, the estimated expression image generation unit 215 may omit the step S50 to the step S52 and may perform the step S56.

In addition, the image generated in the present example embodiment may not intended to be used for person authentication. Therefore, the estimated expression image generation unit 215 may generate a face image with an expression that matches a situation of the person when the image is generated, rather than individuality.

### [5-2: Technical Effect of Information Processing Apparatus 5]

Since the information processing apparatus 5 in the fifth example embodiment generates the estimated expression image on the basis of the previously registered image of the person in which at least the shield area is not hidden, it is possible to obtain the image that is typical of the person in question. In addition, when the image of the person with the expression corresponding to the estimated expression in which at least the shield area is not hidden, is registered in advance, the information processing apparatus 5 generates the estimated expression image on the basis of the image that is registered in advance, and it is thus possible to obtain the image that is more typical of the person.

### 6: Sixth Example Embodiment

An information processing apparatus, an information processing method, and a recording medium according to a sixth example embodiment will be described. The following describes the information processing apparatus, the information processing method, and the recording medium according to the sixth example embodiment, by using an information processing apparatus 6 to which the information processing apparatus, the information processing method, and the recording medium according to the sixth example embodiment are applied.

### [6-1: Configuration of Information Processing Apparatus 6]

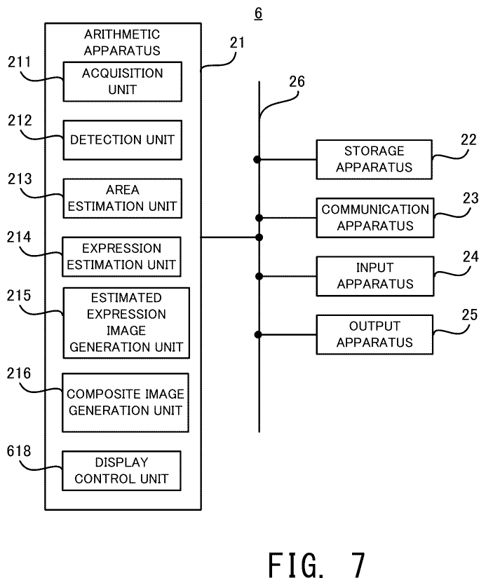

With reference to FIG. 7, a configuration of the information processing apparatus 6 in the sixth example embodiment will be described. FIG. 7 is a block diagram illustrating the configuration of the information processing apparatus 6 in the sixth example embodiment.

As illustrated in FIG. 7, the information processing apparatus 6 in the sixth example embodiment includes the arithmetic apparatus 21 and the storage apparatus 22, as in the information processing apparatus 2 in the second example embodiment to the information processing apparatus 5 in the fifth example embodiment. Furthermore, the information processing apparatus 6 may include the communication apparatus 23, the input apparatus 24, and the output apparatus 25, as in the information processing apparatus 2 in the second example embodiment to the information processing apparatus 5 in the fifth example embodiment. The information processing apparatus 6, however, may not include at least one of the communication apparatus 23, the input apparatus 24, and the output apparatus 25. The information processing apparatus 6 in the sixth example embodiment is different from the information processing apparatus 2 in the second example embodiment to the information processing apparatus 5 in the fifth example embodiment, in that the arithmetic apparatus 21 includes a display control unit 618. Other features of the information processing apparatus 6 may be the same as those of at least one of the other features of the information processing apparatus 2 in the second example embodiment to the information processing apparatus 5 in the fifth example embodiment.

### [6-2: Information Processing Operation Performed by Information Processing Apparatus 6]

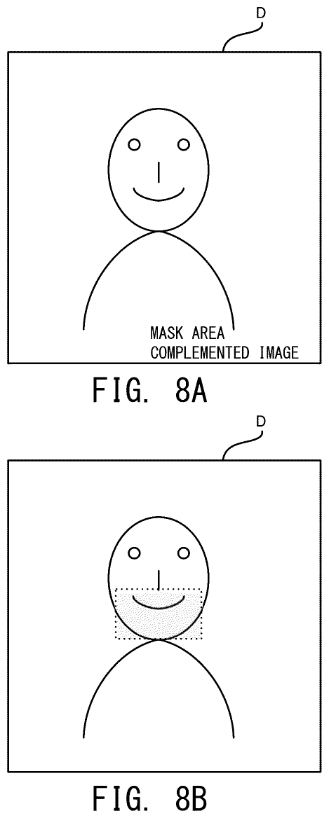

When the composite image generation unit 216 generates the composite image, the display control unit 618 displays the composite image instead of the image, and superimposes and displays information indicating the image generated by the composite image generation unit 216 on the composite image. For example, as illustrated in FIG. 8(a), when the composite image generation unit 216 generates the composite image, the display control unit 618 may display characters such as “mask area complemented image” at the bottom right of a display mechanism D. Alternatively, for example, as illustrated in FIG. 8(b), when the composite image generation unit 216 generates the composite image, the display control unit 618 may superimpose and display a semi-transparent mask on an area corresponding to the mask area in a non-composite image.

### [6-3: Technical Effect of Information Processing Apparatus 6]

Since the information processing apparatus 6 in the sixth example embodiment superimposes and displays the information indicating the composite image, on the composite image when the composite image is displayed, a user is able to easily distinguish whether or not the image is a composite image.

### 7: Seventh Example Embodiment

An online meeting system in a seventh example embodiment will be described. The following describes the online meeting system in the seventh example embodiment, by using an online meeting system 700 to which the online meeting system in seventh example embodiment is applied.

### [7-1: Configuration of Online Meeting System 700]

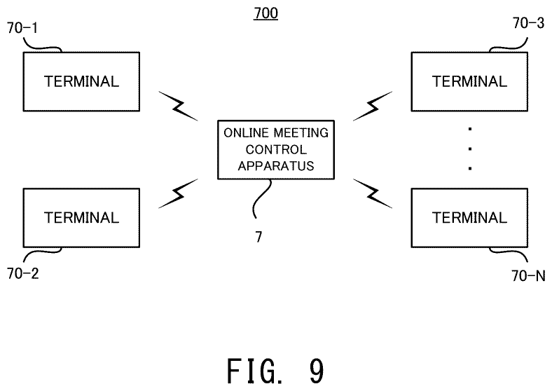

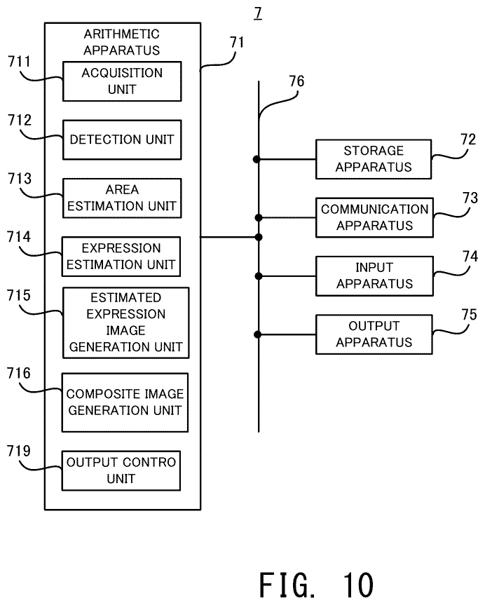

As illustrated in FIG. 9, the online meeting system 700 in the seventh example embodiment may include an online meeting control apparatus 7 and a plurality of terminals 70 (FIG. 9 illustrates terminals 70-1, 70-2, 70-3, . . . , and 70-N). The online meeting control apparatus 7 is configured to communicate with the plurality of terminals 70. The plurality of terminals 70 may perform an online meeting. The plurality of terminals 70 may perform a web conference.

### [7-2: Configuration of Online Meeting Control Apparatus 7]

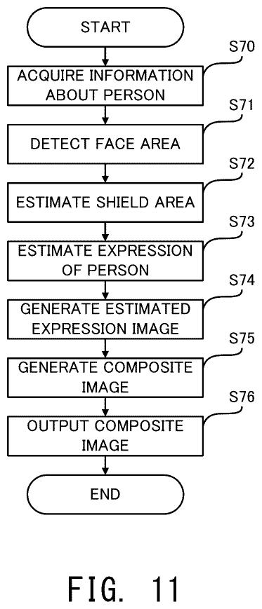

With reference to FIG. 10, a configuration of the online meeting control apparatus 7 will be described. FIG. 10 is a block diagram illustrating the configuration of the online meeting control apparatus 7 in the seventh example embodiment.

As illustrated in FIG. 10, the online meeting control apparatus 7 includes an arithmetic apparatus 71 and a storage apparatus 72. Furthermore, the online meeting control apparatus 7 may include a communication apparatus 73, an input apparatus 74, and an output apparatus 75. The online meeting control apparatus 7, however, may not include at least one of the communication apparatus 73, the input apparatus 74, and the output apparatus 75. The arithmetic apparatus 71, the storage apparatus 72, the communication apparatus 73, the input apparatus 74, and the output apparatus 75 may be connected through a data bus 76.

The arithmetic apparatus 71 includes at least one of a CPU (Central Processing Unit), a GPU (Graphics Processing Unit), and a FPGA (Field Programmable Gate Array), for example. The arithmetic apparatus 71 reads a computer program. For example, the arithmetic apparatus 71 may read a computer program stored by the storage apparatus 72. For example, the arithmetic apparatus 71 may read a computer program stored by a computer-readable and non-transitory recording medium, by using a not-illustrated recording medium reading apparatus provided in the online meeting control apparatus 7 (e.g., the input apparatus 74 described later). The arithmetic apparatus 71 may acquire (i.e., download or read) a computer program from a not-illustrated apparatus disposed outside the online meeting control apparatus 7, through the communication apparatus 73 (or another communication apparatus). The Arithmetic apparatus 71 executes the read computer program. Consequently, a logical functional block for performing an operation to be performed by the online meeting control apparatus 7 is realized or implemented in the arithmetic apparatus 71. That is, the arithmetic apparatus 71 is allowed to function as a controller for realizing or implementing the logical functional block for performing an operation (in other words, processing) to be performed by the online meeting control apparatus 7.

FIG. 10 illustrates an example of the logical functional block realized or implemented in the arithmetic apparatus 71 to perform an online meeting control operation. As illustrated in FIG. 10, an acquisition unit 711 that is a specific example of the “acquired unit” described in Supplementary Note later, a detection unit 712 that is a specific example of the “detected unit” described in Supplementary Note later, an area estimation unit 713 that is a specific example of the “estimated unit” described in Supplementary Note later, an expression estimation unit 714 that is a specific example of the “expression estimation unit” described in Supplementary Note later, an estimated expression image generation unit 715 that is a specific example of the “estimated expression image generation unit” described in Supplementary Note later, a composite image generation unit 716 that is a specific example of the “composite image generation unit” described in Supplementary Note later, and an output control unit 719 that is a specific example of the “output control unit”, are realized or implemented in the arithmetic apparatus 71. Each operation of the acquisition unit 711, the detection unit 712, the area estimation unit 713, the expression estimation unit 714, the estimated expression image generation unit 715, the composite image generation unit 716, and the output control unit 719 will be described later with reference to FIG. 11.

The storage apparatus 72 is configured to store desired data. For example, the storage apparatus 72 may temporarily store a computer program to be executed by the arithmetic apparatus 71. The storage apparatus 72 may temporarily store data that are temporarily used by the arithmetic apparatus 71 when the arithmetic apparatus 71 executes the computer program. The storage apparatus 72 may store data that are stored by the online meeting control apparatus 7 for a long time. The storage apparatus 72 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 72 may include a non-transitory recording medium.

The communication apparatus 73 is configured to communicate with an apparatus external to the online meeting control apparatus 7 through a not-illustrated communication network. The online meeting control apparatus 7 may be configured to communicate with each of the plurality of terminals 70 through the communication apparatus 73.

The input apparatus 74 is an apparatus that receives an input of information to the online meeting control apparatus 7 from an outside of the online meeting control apparatus 7. For example, the input apparatus 74 may include an operating apparatus (e.g., at least one of a keyboard, a mouse, and a touch panel) that is operable by an operator of the online meeting control apparatus 7. For example, the input apparatus 74 may include a r reading apparatus that is configured to read information recorded as data on a recording medium that is externally attachable to the online meeting control apparatus 7.

The output apparatus 75 is an apparatus which outputs information to the outside of the online meeting control apparatus 7. For example, the output apparatus 75 may output information as an image. That is, the output apparatus 75 may include a display apparatus (a so-called display) that is configured to display an image indicating the information that is desirably outputted. For example, the output apparatus 75 may output information as audio/sound. That is, the output apparatus 75 may include an audio apparatus (a so-called speaker) that is configured to output audio/sound. For example, the output apparatus 75 may output information onto a paper surface. That is, the output apparatus 75 may include a print apparatus (a so-called printer) that is configured to print desired information on the paper surface.

### [7-3: Online Meeting Control Operation Performed by Online Meeting Control Apparatus 7]

With reference to FIG. 11, a flow of an online meeting control operation performed by the online meeting control apparatus 7 in the seventh example embodiment will be described. FIG. 11 is a flowchart illustrating the flow of the online meeting control operation performed by the online meeting control apparatus 7 in the seventh example embodiment.

As illustrated in FIG. 11, the acquisition unit 711 acquires the information about the person including at least the image of the person, from at least one of the plurality of terminals 70 that perform a meeting (step S70). The acquisition unit 711 may acquire the information about the person including at least the image of the person who operates the terminal 70. The acquisition unit 711 may acquire the information about the person including a video of the person who operates the terminal 70.

The detection unit 712 detects the face area including the face of the person from the image (step S71). When at least a part of the face area is hidden, the area estimation unit 713 estimates the hidden shield area (step S72). The expression estimation unit 714 estimates the expression of the person on the basis of the information about the person (step S73). The estimated expression image generation unit 715 generates the estimated expression image of the area corresponding to the shield area, in accordance with the expression estimated by the expression estimation unit 714 (step S74). The composite image generation unit 716 generates the composite image on the basis of the image and the estimated expression image (step S75).

The operation performed by the detection unit 712 may be the same as the operation performed by at least one of the detection units 212 in the second to sixth example embodiments. The operation performed by area estimation unit 713 may be the same as the operation performed by at least one of the area estimation units 213 in the second to sixth example embodiments. The operation performed by the expression estimation unit 714 may be the same as the operation performed by at least one of the expression estimation units 214 in the second to sixth example embodiments. The operation performed by the estimated expression image generation unit 715 may be the same as the operation performed by at least one of the estimated expression image generation units 215 in the second to sixth example embodiments. The operation performed by the composite image generation unit 716 may be the same as the operation performed by at least one of the composite image generation units 216 in the second to sixth example embodiments.

When the composite image generation unit 716 generates the composite image, the output control unit 719 outputs the composite image to the plurality of terminals 70, instead of the image (step S76). When the acquisition unit 711 acquires the video of the person who operates the terminal 70, the output control unit 719 may output the image or the composite image to the plurality of terminals 70 in real time. Alternatively, when outputting the composite image to the plurality of terminals 70, the output control unit 719 may output it in late timing as compared with a case of outputting the image to the plurality of terminals 70. When outputting the composite image to the plurality of terminals 70, the output control unit 719 may output it with a delay of several seconds or the like, as compared with a case of outputting the image to the plurality of terminals 70, for example.

Even in at least one of the information processing apparatus in the second example embodiment 2 to the information processing apparatus 6 in the sixth example embodiment, the composite image generation operation may be performed in real time. Alternatively, even in at least one of the information processing apparatus in the second example embodiment 2 to the information processing apparatus 6 in the sixth example embodiment, there may be a time lag of several seconds or the like, for example.

In addition, when the acquisition unit 711 acquires a still image of the person who operates the terminal 70, a learning unit 717 may generate the composite image offline, and the output control unit 719 may output the composite image generated offline to the plurality of terminals 70.

When the acquisition unit 711 acquires the information about the person including the video of the person, the area estimation unit 713 may not perform the estimation processing for each frame. That is, the area estimation unit 713 may perform the estimation processing for each predetermined number of frames. That is, the expression estimation unit 714 may generate the estimated expression image according to the same expression for the predetermined number of frames.

Furthermore, in the online meeting control apparatus 7 in the seventh example embodiment, the arithmetic apparatus 71 may include the learning unit 717. That is, as in the learning unit 417 in the fourth example embodiment, the learning unit 717 may cause the expression estimation unit 714 to learn the method of estimating the expression of the person on the basis of the expression label and an estimation result of the expression of the sample person by the expression estimation unit 714.

Furthermore, in the online meeting control apparatus 7 in the seventh example embodiment, the arithmetic apparatus 71 may include a display control unit 718. That is, as in the display control unit 618 in the sixth example embodiment, when the composite image generation unit 716 generates the composite image, the display control unit 718 may display the composite image instead of the image, and may superimpose and display information indicating the image generated by the composite image generation unit 716 on the composite image.

### [7-4: Technical Effect of Online Meeting Control Apparatus 7]

Since the online meeting control apparatus 7 in the seventh example embodiment generates the composite image on the basis of the image and the image of the mask area according to the estimated expression of the person, it is possible to acquire the image according to the expression of the person in which the mouth of the person is not hidden, even when the person is wearing the mask.

Due to recent changes in hygiene awareness, it is recommended that people wear masks, especially in a crowded place. Although a person wishes to participate in an online communication without a mask, when the person participates from a common location such as a satellite office, it is recommended to wear the mask. That is, there is a demand to distribute a natural face image without the mask, even in a place where people are hesitant to take off masks, such as a crowded place.

In contrast, since the online meeting control apparatus 7 in the seventh example embodiment generates the composite image without the mask on the basis of the image of the area corresponding to the mask area, in accordance with the estimated expression of the person when the person is wearing the mask, it is possible to provide the natural face image without the mask. Therefore, even when the person participates from a common location such as a satellite office, it is possible to distribute the natural face image without the mask.

### 9: Supplementary Notes

With respect to the example embodiment described above, the following Supplementary Notes are further disclosed.

### [Supplementary Note 1]

An information processing apparatus including:
an acquisition unit that acquires information about a person including at least an image of the person;
a detection unit that detects a face area including a face of the person from the image;
an estimation unit that estimates a hidden shield area in a case where at least a part of the face area is hidden;
an expression estimation unit that estimates an expression of the person on the basis of the information about the person;
an estimated expression image generation unit that generates an estimated expression image of an area corresponding to the shield area, in accordance with the expression estimated by the expression estimation unit; and
a composite image generation unit that generates a composite image on the basis of the image and the estimated expression image.

### [Supplementary Note 2]

The information processing apparatus according to Supplementary Note 1, wherein the shield area that is at least a hidden part of the face area, is a mask area hidden by a mask worn by the person.

### [Supplementary Note 3]

The information processing apparatus according to Supplementary Note 2, wherein the expression estimation unit estimates the expression of the person on the basis of an area around eyes of the person.

### [Supplementary Note 4]

The information processing apparatus according to any one of Supplementary Notes 1 to 3, wherein
the acquisition unit acquires learning information including sample information about a sample person with a predetermined expression and an expression label indicating the predetermined expression,
the expression estimation unit estimates an expression of the sample person on the basis of the sample information, and
the information processing apparatus further includes a learning unit that causes the expression estimation unit to learn a method of estimating the expression of the person on the basis of the expression label and an estimation result of the expression of the sample person by the expression estimation unit.

### [Supplementary Note 5]

The information processing apparatus according to any one of Supplementary Notes 1 to 3, wherein the estimated expression image generation unit generates the estimated expression image on the basis of a previously registered image of the person in which at least the shield area is not shielded.

### [Supplementary Note 6]

The information processing apparatus according to Supplementary Note 5, wherein the estimated expression image generation unit generates the estimated expression image on the basis of the previously registered image of the person with an expression corresponding to the expression estimated by the expression estimation unit.

### [Supplementary Note 7]

The information processing apparatus according to any one of Supplementary Notes 1 to 3, further including a display control unit that displays the composite image instead of the image in a case where the composite image generation unit generates the composite image, and that superimposes and displays information indicating the image generated by the composite image generation unit on the composite image.

### [Supplementary Note 8]

An online meeting system including:
an acquisition unit that acquires information about a person including at least an image of the person, from at least one of a plurality of terminals that perform a meeting;
a detection unit that detects a face area including a face of the person from the image;
an estimation unit that estimates a hidden shield area in a case where at least a part of the face area is hidden;
an expression estimation unit that estimates an expression of the person on the basis of the information about the person;
an estimated expression image generation unit that generates an estimated expression image of an area corresponding to the shield area, in accordance with the expression estimated by the expression estimation unit;
a composite image generation unit that generates a composite image on the basis of the image and the estimated expression image; and
an output control unit that outputs the composite image to the plurality of terminals instead of the image, in a case where the composite image generation unit generates the composite image.

### [Supplementary Note 9]

An information processing method including:
acquiring information about a person including at least an image of the person;
detecting a face area including a face of the person from the image;
estimating a hidden shield area in a case where at least a part of the face area is hidden;
estimating an expression of the person on the basis of the information about the person;
generating an estimated expression image of an area corresponding to the shield area, in accordance with the estimated expression; and
generating a composite image on the basis of the image and the estimated expression image.

### [Supplementary Note 10]

A recording medium on which a computer program that allows a computer to execute an information processing method is recorded, the information processing method including:
acquiring information about a person including at least an image of the person;
detecting a face area including a face of the person from the image;
estimating a hidden shield area in a case where at least a part of the face area is hidden;
estimating an expression of the person on the basis of the information about the person;
generating an estimated expression image of an area corresponding to the shield area, in accordance with the estimated expression; and
generating a composite image on the basis of the image and the estimated expression image.

This disclosure is not limited to the examples described above and is allowed to be changed, if desired, without departing from the essence or spirit of this disclosure which can be read from the claims and the entire identification. An information processing apparatus, an information processing method, and a recording medium with such changes are also intended to be within the technical scope of this disclosure.

### DESCRIPTION OF REFERENCE CODES

1, 2, 3, 4, 5, 6 Information processing apparatus
11, 211, 711 Acquisition unit
12, 212, 712 Detection unit
13, 213, 713 Area estimation unit
14,214,714 Expression estimation unit
15, 215, 715 Estimated expression image generation unit
16, 216, 716 Composite image generation unit
417, 717 Learning unit
618, 718 Display control unit
700 Online meeting system
7 Online meeting control apparatus
70 Terminal
719 Output control unit

What is claimed is:

1. An information processing apparatus comprising:
at least one memory that is configured to store instructions; and
at least one processor that is configured to execute the instructions to:
acquire information about a person including at least an image of the person;
detect a face area including a face of the person from the image;
estimate a hidden shield area in a case where at least a part of the face area is hidden;
estimate an expression of the person on the basis of the information about the person;
generate an estimated expression image of an area corresponding to the shield area, in accordance with the estimated expression; and
generate a composite image on the basis of the image and the estimated expression image.

2. The information processing apparatus according to claim 1, wherein the shield area that is at least a hidden part of the face area, is a mask area hidden by a mask worn by the person.

3. The information processing apparatus according to claim 2, wherein the at least one processor is configured to execute the instructions to estimate the expression of the person on the basis of an area around eyes of the person.

4. The information processing apparatus according to claim 1, wherein the at least one processor is configured to execute the instructions to:
acquire learning information including sample information about a sample person with a predetermined expression and an expression label indicating the predetermined expression,
estimate an expression of the sample person on the basis of the sample information, and
learn a method of estimating the expression of the person on the basis of the expression label and an estimation result of the expression of the sample person.

5. The information processing apparatus according to claim 1, wherein the at least one processor is configured to execute the instructions to generate the estimated expression image on the basis of a previously registered image of the person in which at least the shield area is not shielded.

6. The information processing apparatus according to claim 5, wherein the at least one processor is configured to execute the instructions to generate the estimated expression image on the basis of the previously registered image of the person with an expression corresponding to the estimated expression.

7. The information processing apparatus according to claim 1, wherein the at least one processor is configured to execute the instructions to: display the composite image instead of the image in a case where the composite image is generated; and that superimpose and display information indicating the generated image on the composite image.

8. (canceled)

9. An information processing method comprising:
acquiring information about a person including at least an image of the person;
detecting a face area including a face of the person from the image;
estimating a hidden shield area in a case where at least a part of the face area is hidden;
estimating an expression of the person on the basis of the information about the person;
generating an estimated expression image of an area corresponding to the shield area, in accordance with the estimated expression; and
generating a composite image on the basis of the image and the estimated expression image.

10. A non-transitory recording medium on which a computer program that allows a computer to execute an information processing method is recorded, the information processing method including:
acquiring information about a person including at least an image of the person;
detecting a face area including a face of the person from the image;
estimating a hidden shield area in a case where at least a part of the face area is hidden;
estimating an expression of the person on the basis of the information about the person;
generating an estimated expression image of an area corresponding to the shield area, in accordance with the estimated expression; and
generating a composite image on the basis of the image and the estimated expression image.
